(19) United States
(12) Patent Application Publication
(10) Pub. No.: US 2007/0071324 A1
(43) Pub. Date: Mar. 29, 2007

(54) Method for determining corners of an object represented by image data

(75) Inventor: Khageshwar Thakur, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/236,031

(22) Filed: Sep. 27, 2005

(51) Int. Cl. G06K 9/48; G06K 9/36

(52) U.S. Cl. 382/199; 382/291

(57) ABSTRACT

A method for determining corners of an object represented by image data includes determining edge data associated with the object; finding estimated corners for the edge data; determining segment data of the edge data by ignoring data within a predetermined distance from the estimated corners; extending the segment data to define a plurality of lines having points of intersection; and defining ideal corners at the points of intersection of the plurality of lines.

### BACKGROUND OF THE INVENTION

1. Field of the Invention

The present invention relates to boundary detection, and, more particularly, to a method for determining corners of an object represented by image data.

2. Description of the Related Art

An imaging apparatus is used to process image data, and may be used to generate a printed output corresponding to the image data. The image data may be received, for example, from an application program executing on a computer, from memory, or from a scanner. For example, the scanner, which may be included in the imaging apparatus, may be used to generate a digital representation of a substrate object being scanned. Such a substrate object, such as a document, may include any of a variety of media types, such as paper, card stock, etc., and may be regular (e.g., rectangular) or irregular in shape. On the substrate object there may be formed, for example, text, graphics or a picture, e.g., a photo, or a combination thereof. During a scanning operation, image data is generated, including background image data associated with a backing surface of the scanner and foreground image data representing the scanned object, e.g., substrate, along with any text, graphics or a picture formed on the substrate

Knowing the boundaries of the scanned object, such as a business card or photograph, is useful to increase the accuracy of skew correction. Knowing the boundaries of the scanned object also enables the accurate placement of the contents of the object, e.g., text, graphics, or picture, with respect to a printed output. However, often it may be difficult to detect the appropriate boundaries, and particular the corners, of the object. For example, the corners of the object may be damaged prior to scanning, or the scanning process may generate imaging distortion, i.e., “noise” present in the image data, thereby making the determination of the corners of the object difficult. The knowledge of corners may help to determine the size, shape and orientation of objects. The size, shape and orientation information may be used to format and perform skew correction of the image. This information also may be used for other cosmetic corrections.

### SUMMARY OF THE INVENTION

The invention, in one form thereof, is directed to a method for determining corners of an object represented by image data. The method includes determining edge data associated with the object; finding estimated corners for the edge data; determining segment data of the edge data by ignoring data within a predetermined distance from the estimated corners; extending the segment data to define a plurality of lines having points of intersection; and defining ideal corners at the points of intersection of the plurality of lines.

The invention, in another form thereof, is directed to a method for determining corners of an object represented by image data. The method includes processing the image data to generate a cyclic edge data list of connected points along edges of the object; identifying an origin point P0 from the connected points; fetching a first point P₋ₙ a distance DL from point P0 in a clockwise direction in the cyclic edge data list, wherein n is a count value; fetching a second point P₊ₙ a distance DR from P0 in a counterclockwise direction in the cyclic edge data list; determining a distance DH between the first point P₋ₙ and the second point P₊ₙ; and if DH²=DL²+DR²+Tr, wherein Tr is a tolerance range, then point P0 is designated as an estimated corner.

The invention, in another form thereof, is directed to a method for determining corners of an object represented by image data. The method includes (a) processing the image data to generate a cyclic edge data list of connected points along edges of the object; (b) filtering out any branched edges in the cyclic edge data list; (c) identifying an origin point P0 from the connected points; (d) fetching a first point P₋ₙ a distance DL from point P0 in a clockwise direction in the cyclic edge data list, wherein n is a count value; (e) fetching a second point P₊ₙ, a distance DR from P0 in a counterclockwise direction in the cyclic edge data list; (f) determining a distance DH between the first point P₋ₙ and the second point P₊ₙ; and (g) if DH²>DL²+DR²+Tr, then point P0 is not at an estimated corner, then the method further (h) selecting a new origin point P0=P0+k, wherein k is an offset count value; and (i) repeating acts (d) though (g).

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system embodying the present invention.

FIG. 2 is a diagrammatic representation of an embodiment of the scanner unit used in the imaging system of FIG. 1.

FIG. 3 illustrates light originating from the illuminant of the scanner head, and light emitted by the phosphorescent material of the phosphorescent area of the document pad, of FIG. 2.

FIG. 4A shows exemplary substrate objects positioned against the background provided by the phosphorescent area of the document pad of FIG. 2.

FIG. 4B shows an exemplary representation of a dark image of the substrate objects of FIG. 4A generated using the light emitted by the phosphorescent material from the phosphorescent area of the document pad of FIG. 2.

FIG. 4C illustrates the edges of the substrate objects of FIG. 4A.

FIG. 5 is a flowchart of a method for determining corners of an object represented by image data, in accordance with the present invention.

FIG. 6 is a flowchart of an exemplary process for finding estimated corners in the method of FIG. 5.

FIG. 7A, 7B and 7C are graphical aids for understanding exemplary algorithms used in the process of FIG. 6.

FIG. 8 is a magnified graphical representation of the edge data of one of the substrate objects, showing rounded corners and/or local disturbances, e.g., wiggles, particularly near the estimated corners.

FIG. 9 illustrates the location of the ideal corners of the substrate object as a result of performing the method of FIG. 5.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

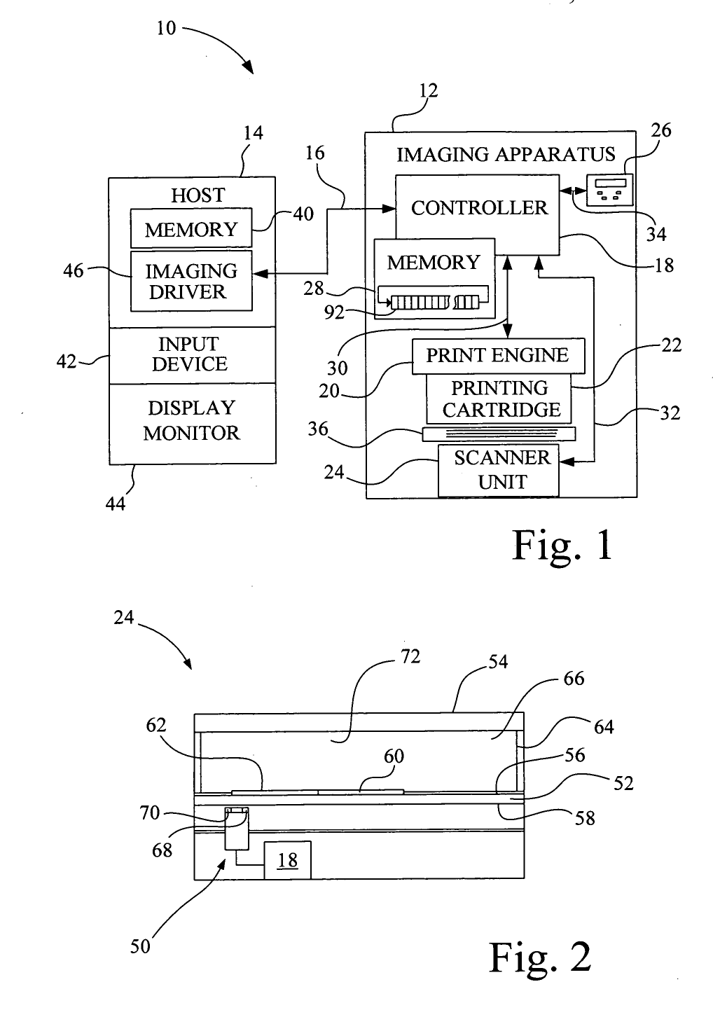

Referring now to the drawings and particularly to FIG. 1, there is shown a diagrammatic depiction of an imaging system 10 embodying the present invention. As shown, imaging system 10 may include an imaging apparatus 12 and a host 14. Imaging apparatus 12 communicates with host 14 via a communications link 16. As used herein, the term “communications link” is used to generally refer to structure that facilitates electronic communication between multiple components, and may operate using wired or wireless technology.

Imaging apparatus 12 may be, for example, an ink jet printer and/or copier; an electrophotographic printer and/or copier; a thermal transfer printer and/or copier; an all-in-one (AIO) unit that includes a print engine, a scanner unit, and possibly a fax unit; or may be simply just a scanner unit. An AIO unit is also known in the art as a multifunction machine. In the embodiment shown in FIG. 1, however, imaging apparatus 12 is shown as a multifunction machine that includes a controller 18, a print engine 20, a printing cartridge 22, a scanner unit 24, and a user interface 26. Imaging apparatus 12 may communicate with host 14 via a standard communication protocol, such as for example, universal serial bus (USB), Ethernet or IEEE 812.1x.

Controller 18 includes a processor unit and associated memory 28, and may be formed as one or more Application Specific Integrated Circuits (ASIC). Memory 28 may be, for example, random access memory (RAM), read only memory (ROM), and/or non-volatile RAM (NVRAM). Alternatively, memory 28 may be in the form of a separate electronic memory (e.g., RAM, ROM, and/or NVRAM), a hard drive, a CD or DVD drive, or any memory device convenient for use with controller 18. Controller 18 may be a printer controller, a scanner controller, or may be a combined printer and scanner controller. In the present embodiment, controller 18 communicates with print engine 20 via a communications link 30. Controller 18 communicates with scanner unit 24 via a communications link 32. User interface 26 is communicatively coupled to controller 18 via a communications link 34. Controller 18 serves to process print data and to operate print engine 20 during printing, as well as to operate scanner unit 24 and process data obtained via scanner unit 24.

In the context of the examples for imaging apparatus 12 given above, print engine 20 can be, for example, an ink jet print engine, an electrophotographic print engine or a thermal transfer engine, configured for forming an image on a print medium 36, such as a sheet of paper, transparency or fabric. As an ink jet print engine, for example, print engine 20 operates printing cartridge 22 to eject ink droplets onto print medium 36 in order to reproduce text and/or images. As an electrophotographic print engine, for example, print engine 20 causes printing cartridge 22 to deposit toner onto print medium 36, which is then fused to print medium 36 by a fuser (not shown), in order to reproduce text and/or images.

Host 14, which may be optional, may be, for example, a personal computer, including memory 40, such as RAM, ROM, and/or NVRAM, an input device 42, such as a keyboard, and a display monitor 44. Host 14 further includes a processor, input/output (I/O) interfaces, and at least one mass data storage device, such as a hard drive, a CD-ROM and/or a DVD unit.

Host 14 includes in its memory a software program including program instructions that function as an imaging driver 46, e.g., printer/scanner driver software, for imaging apparatus 12. Imaging driver 46 is in communication with controller 18 of imaging apparatus 12 via communications link 16. Imaging driver 46 facilitates communication between imaging apparatus 12 and host 14, and may provide formatted print data to imaging apparatus 12, and more particularly, to print engine 20, to print an image.

In some circumstances, it may be desirable to operate imaging apparatus 12 in a standalone mode. In the standalone mode, imaging apparatus 12 is capable of functioning without host 14. Accordingly, all or a portion of imaging driver 46, or a similar driver, may be located in controller 18 of imaging apparatus 12 so as to accommodate printing during a copying or facsimile job being handled by imaging apparatus 12 when operating in the standalone mode.

Scanner unit 24 may be of a conventional scanner type, such as for example, a sheet feed or flat bed scanner. In the context of the present invention, in some embodiments either scanner type may be used. As is known in the art, a sheet feed scanner transports a document to be scanned past a stationary sensor device.

Referring to FIG. 2, there is shown an embodiment of the present invention where scanner unit 24 is a flat bed scanner. Scanner unit 24 includes a scanner head 50 (e.g., a scan bar), a document glass 52 and a scanner lid 54. Document glass 52 has a first side 56 that faces scanner lid 54, and a second side 58 that faces away from scanner lid 54. First side 56 of document glass 52 provides support for one or more objects, such as substrate object 60 and a substrate object 62, during a scanning operation. In this example, substrate objects 60, 62 may be rectangular business cards randomly placed on document glass 52.

FIG. 2 shows scanner unit 24 with scanner lid 54 in an open position. Scanner lid 54 may be moved from the open position, as shown in FIG. 2, to a closed position that covers document glass 52. Affixed to scanner lid 54 is a document pad 64. Document pad 64 has a surface 66 that forms a background for substrate objects 60, 62 being scanned. Scanner head 50 includes an illuminant 68, e.g., one or more lamps, LED arrays, etc., and a sensor 70, e.g., one or more reflectance sensor arrangements, that are scanned across the substrate objects 60, 62 to collect image data relating to substrate objects 60, 62. Each of illuminant 68 and sensor 70 is positioned to face second side 58, e.g., the under side, of document glass 52. Each of illuminant 68 and sensor 70 is communicatively coupled to controller 18.

In the present embodiment, surface 66 of document pad 64 may be made of a phosphorescent material that forms a phosphorescent area 72 located opposite sensor 70. The phosphorescent material may be obtained, for example, from United Minerals and Chemical Corporation (UMC) of Lyndhurst, N.J. The phosphorescent material is charged, i.e., absorbs light, when exposed to a light source, and discharges, i.e., emits, light after being charged. In one embodiment, for example, phosphorescent area 72 is formed by a phosphorescent coating, such as a phosphorescent paint, applied to a substrate, such as a plastic plate forming a portion of document pad 64. Also, it is contemplated that the phosphorescent material may be sprinkled, in a dry or liquid form, on to a holding layer, which may include an adhesive binder. In these examples, therefore, the phosphorescent material may be applied uniformly or non-uniformly in phosphorescent area 72. In addition, the phosphorescent material may be applied in phosphorescent area 72 in a predetermined pattern, such as for example, a grid pattern.

The light source that charges the phosphorescent material may be, for example, illuminant 68, or some other controlled illuminant, providing dedicated or leaked light, or may be ambient light. In order to charge the phosphorescent material using ambient light, scanner lid 54 is place in the open position so that ambient light may reach phosphorescent area 72. Illuminant 68 may be, for example, the same illuminant used to collect RGB data from substrate objects 60, 62 via scanner head 50.

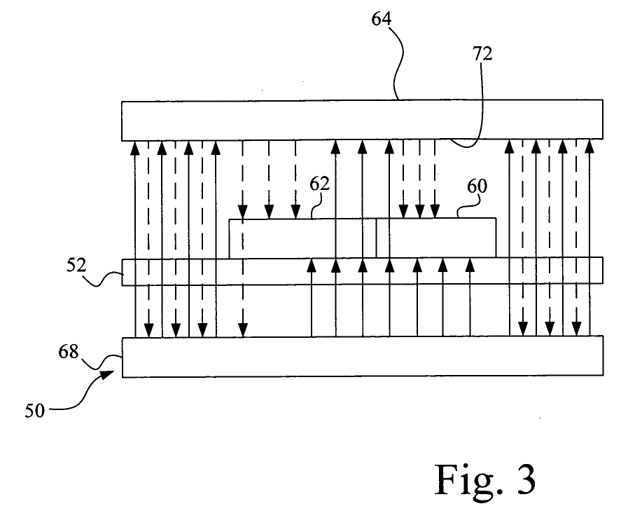

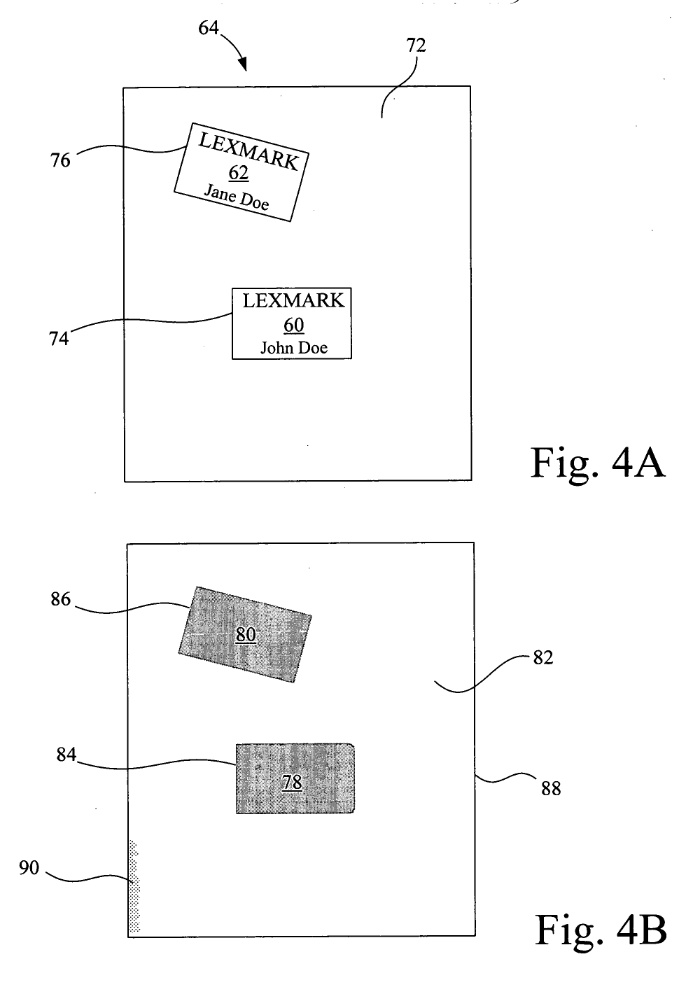

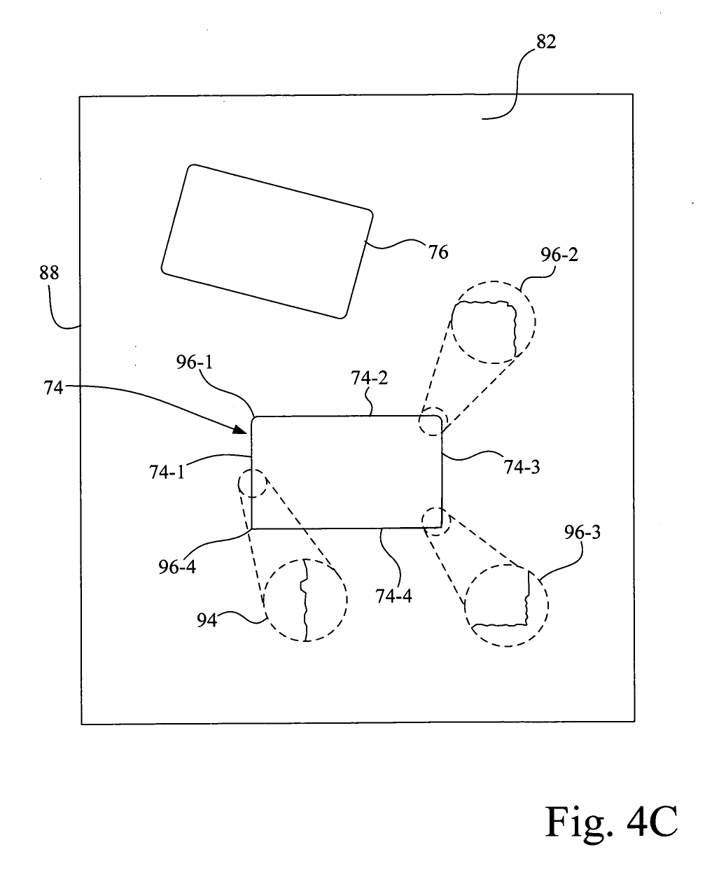

In the embodiment shown in FIG. 2, the phosphorescent material forming phosphorescent area 72 is positioned to face first side 56 of document glass 52. In the illustration of FIG. 3, light originating from illuminant 68 of scanner head 50 is represented by solid arrowed lines, and light emitted by the phosphorescent material of phosphorescent area 72 of document pad 64 is represented by dashed arrowed lines. FIG. 4A shows substrate objects 60, 62 positioned against the background provided by phosphorescent area 72. Substrate object 60 has a border, i.e., edges, 74 and substrate object 62 has a border, i.e., edges, 76. In this example, each of substrate objects 60 and 62 is a rectangular medium on which a picture and/or text data is formed.

As shown in FIG. 3, when substrate objects 60, 62 are positioned between document pad 64 and scanner head 50, light is attenuated during the charge of the phosphorescent material (represented by the shorter solid arrowed lines) and is attenuated during the discharge of the phosphorescent material (represented by the shorter dashed arrowed lines) in the area associated with substrate objects 60, 62. Accordingly, and referring to FIG. 4B, during light emission of the phosphorescent material of phosphorescent area 72 in the substantial absence of light from other sources, a dark image 78 of substrate object 60 and a dark image 80 of substrate object 62 are formed that may be sensed by sensor 70. Dark images 78, 80 have a high contrast ratio with respect to the background 82 defined by the portion of phosphorescent area 72 that is not attenuated by substrate objects 60, 62.

Referring to FIGS. 2 and 3, during one exemplary scanning operation, for example, substrate objects 60, 62 are positioned between sensor 70 and phosphorescent area 72. As shown in the embodiment of FIGS. 4A and 4B, phosphorescent area 72 is greater than a surface area of substrate objects 60, 62. Controller 18 executes program instructions to control illuminant 68 and to read sensor 70 to collect RGB (three channel) image data associated with substrate objects 60, 62, and to collect dark image (fourth channel) data associated with dark image 78 of substrate object 60 and dark image 80 of substrate object 62. However, controller 18 may use only the dark image data relating to a boundary 84 of dark image 78 and boundary 86 of dark image 80, and not the RGB image data, to determine the edges 74 of substrate object 60.

For example, in order to generate the dark image data, sensor 70 provides signals to controller 18 relating to light emitted by the phosphorescent material at various locations on phosphorescent area 72, wherein substrate objects 60, 62 is sensed by sensor 70 as dark image 78 and dark image 80 in comparison to the background 82 formed by the portion of phosphorescent area 72 not attenuated by substrate object 60 (see FIGS. 2, 3 and 4B).

In some embodiments of the present invention, the dark image data (D) may be generated to be interleaved with regular RGB image data, and this may be achieved in several different ways.

For example, one way is for controller 18 to take one or more dark image readings with sensor 70 after every RGB image reading taken with sensor 70. This may be represented by the sequence: RGB.DDD.RGB.DDD. . . , where D represents a dark image reading and RGB represent the red, green, blue image readings, respectively.

In the event it is determined that taking triple dark image readings after each RGB reading is not necessary in order to build a suitable boundary edge map of boundaries 84, 86 of dark images 78 and 80, respectively, representing the edges 74 of substrate object 60 and the edges 76 of substrate object 62, then controller 18 may take multiple RGB readings with sensor 70 before taking each of the triple dark image readings with sensor 70, so that the overall number of dark image readings may be reduced. For example, this sequence may be: RGB.RGB.RGB.DDD.RGB.RGB. . . . As a further reduction, each of the triple dark image readings may be reduced to a double or single dark image reading, exhibited by the sequence: RGB.RGB.RGB.D.RGB.RGB. . . . By reducing the number of dark image readings D, the RGB image resolution is increased.

In embodiments where illuminant 68 is used in collecting RGB image data relating to the content of substrate objects 60, 62 and for charging the phosphorescent material at phosphorescent area 72, the phosphorescent material is charged when illuminant 68 is ON, and controller 18 executes program instructions to turn OFF illuminant 68 while light emitted by the phosphorescent material is being sensed by sensor 70.

As another example, where ambient light is used to charge the phosphorescent material, the ambient light is substantially blocked, such as by closing scanner lid 54, while the light emitted by the phosphorescent material is being sensed by sensor 70.

The present invention provides corner detection and correction for objects, such as substrate objects 60, 62. The corner information may then be used, for example, by controller 18 to define and de-skew the RGB image data that corresponds to substrate objects 60, 62. Thereafter, print engine 20 may be used to print the de-skewed RGB image data associated with substrate objects 60, 62, if desired.

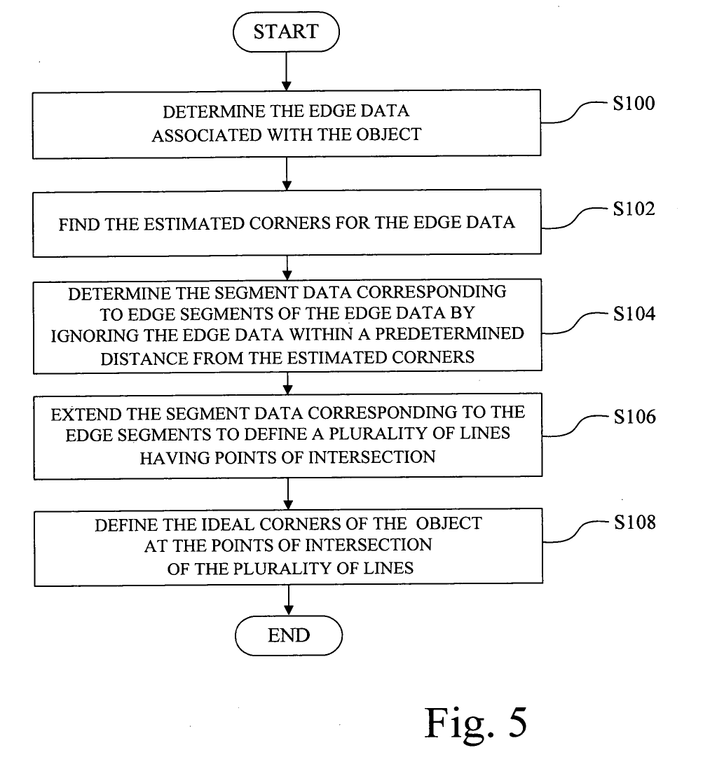

FIG. 5 is a flowchart of a method for determining corners of an object represented by image data, in accordance with the present invention. For ease of understanding, the present invention will be described with respect to determining the corners of substrate object 60 in image data, as an example. However, those skilled in the art will recognize that the method may also be applied to finding the corners of substrate object 62 in image data. In addition, those skilled in the art will recognize that the method may be applied to image data not generated by a scanner, such as from image data generated by a software application or digital camera, to finding the corners of objects within the image data. For example, the method may be used to analyze image data generated via satellite imagery to find the corners of a building, or other structure.

At step S100, edge data associated with the object, such as substrate object 60, is determined. In the present example, the image data is generated during a scanning operation, and substrate object 60 may be, for example, a business card, or a photograph.

As illustrated in FIG. 4B, image data irregularities, such as image noise 90 occurring near the outer boundary 88 of the image data, may be removed by a data clipping process prior to edge detection. For example, the image data at outer boundary 88 may be converted to the background intensity level of background 82. The clipped image may then run through a few passes of dilation and erosion to reduce noise from the interior portions of the image data, resulting in the clean image data represented in FIG. 4C.

Referring to FIGS. 4B and 4C, for example, image data, including outer boundary data associated with outer boundary 88 of the imaging area, background data associated with background 82, and foreground data, i.e., dark image data associated with dark image 78, the edge data associated with edges 74, and the RGB image data, associated with substrate object. 60, may be processed by controller 18, or in other embodiments by other firmware or software residing in imaging apparatus 12 and/or host 14. In other words, background 82 is represented in the image data at a background level, and the foreground data is the image data that corresponds to substrate object 60. In addition, in some embodiments, the image data may include RGB data associated with the graphical or text contents of substrate object 60. The dark image data associated with dark image 78 is separated from the other image data. For example, the background data associated with background 82 may be distinguished based on the high contrast between the two to determine the boundary 84 of dark image 78. Likewise, the boundary 86 of dark image 80 may be found in the same manner.

As a more particular example, the image data is processed through a Depth First Search (DFS) algorithm to generate a cyclic edge data list 92 of connected points along the edges of the object, e.g., edges 74, of substrate object 60. Cyclic edge data list 92 may be established, for example, in memory 28 (see FIG. 1). Accordingly, the cyclic edge data list 92 for substrate object 60 has edge data which includes four substantially orthogonal edge portions 74-1, 74-2, 74-3, and 74-4, as shown in FIG. 4C. The DFS has the advantage that it gives least priority to branched edges, such as branched edges 94 occurring along edge portion 74-1. Therefore, the branched edges 94 are automatically placed initially at the end of the cyclic edge data list 92. This allows the branched edges 94 to be easily filtered, e.g., removed, from the cyclic edge data list 92.

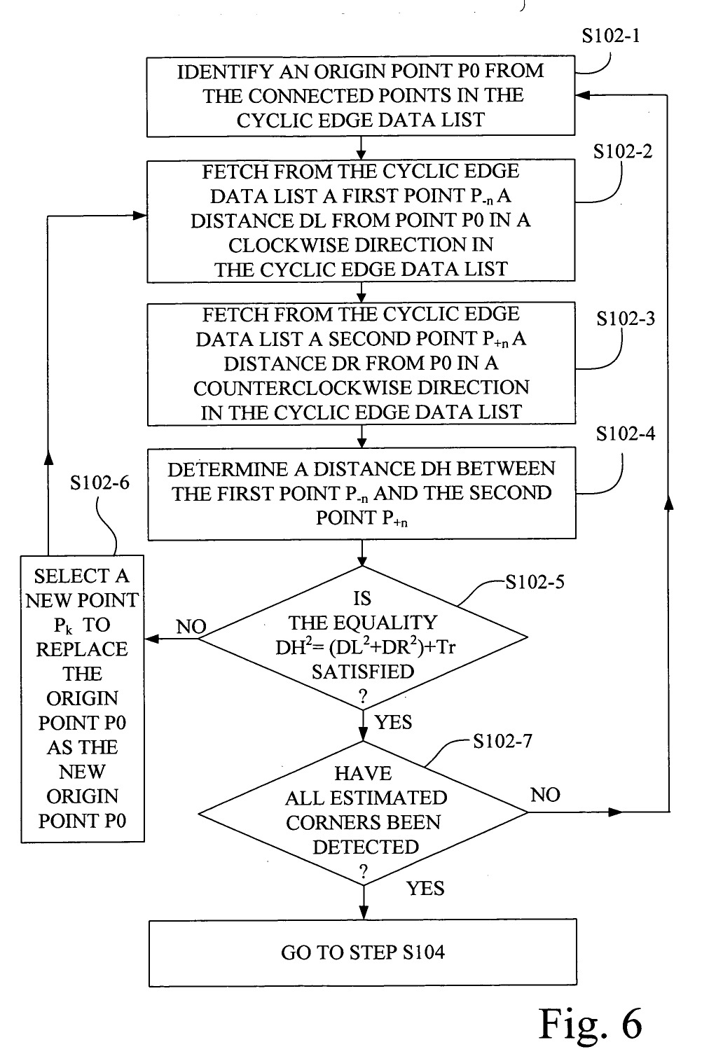

At step S102, the estimated corners for the edge data are found. The details of one embodiment for performing step S102 for estimating corners will be described with respect to the flowchart of FIG. 6. The Appendix includes a code segment that summarizes an exemplary algorithm for finding the estimated corners in accordance with the process of FIG. 6.

At step S102-1, an origin point P0 from the plurality of connected points in the cyclic edge data list 92 is identified.

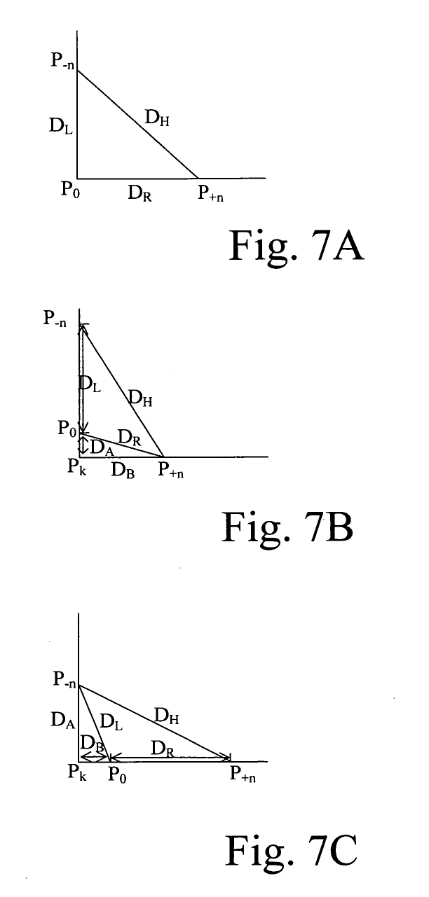

At step S102-2, referring to FIG. 7A, a first point P₋ₙ, a distance DL from point P0 in a clockwise direction in the cyclic edge data list 92 is fetched from the cyclic edge data list 92, wherein n is a count value and the distance is an aerial distance. An aerial distance provides for noise tolerance, since a straight line distance between two points is used, as opposed to using a distance associated with following a path through the cyclic edge data list 92, which would follow the path of the edge data associated with edges 74 and may not be a straight line.

At step S102-3, a second point P₊ₙ, a distance DR from P0 in a counterclockwise direction in the cyclic edge data list 92 is fetched from the cyclic edge data list 92, wherein n is a count value and the distance is an aerial distance.

At step S102-4, a distance DH between the first point P₋ₙ and the second point P₊ₙ is determined, wherein the distance is an aerial distance.

At step S102-5, it is determined whether the Pythagorean equality DH²=(DL²+DR²)+Tr is satisfied. The variable Tr is an optional tolerance range. For example, by setting Tr=0, the tolerance factor is removed from the equation. In embodiments that include a tolerance range, one example is that the tolerance range Tr may be: 0.0<Tr<0.1 millimeters.

If the result of the determination at step S102-5 is NO, then DH²>DL²+DR²+Tr, and it is determined that the estimated corner has not been found. In this case, the process proceeds to step S102-6.

At step S102-6, referring to FIG. 7B, a new point Pₖ is selected to replace the origin point P0, i.e., the new P0=P0+k is selected, wherein k is an offset count value, and the process returns to step S102-2.

In this case, the next point Pₖ, i.e., the new origin point P0, may be selected as follows:
First: (D_{L}+D_{A})²+D_{B}²=D_{H}²
Or, D_{L}²+D_{A}²+2·D_{L}·D_{A}+D_{B}²=D_{H}²
Also, D_{A}+D_{B}²=D_{R}²

Combining the above two equations, we get:

$${D}_{L}^{2} + 2 \cdot {D}_{L} \cdot {D}_{A} + {D}_{R}^{2} = {D}_{H}^{2}$$

$$Or , 2 \cdot {D}_{L} \cdot {D}_{A} = {D}_{H}^{2} - {D}_{L}^{2} - {D}_{R}^{2}$$

$$Or , {D}_{A} = \frac{{D}_{H}^{2} - {D}_{L}^{2} - {D}_{R}^{2}}{2 \cdot {D}_{L}}$$

D_{A} is the aerial distance of the desired point from the previous origin point P0. However, the pixel counts k from P0 in the cyclic edge data list 92 to fetch the point Pₖ, i.e., new P0=P0+k. The aerial distance D_{L} is known and corresponds to pixel counts n. Therefore, count k can be calculated by the equation:

$$k = \frac{{D}_{A} \cdot n}{{D}_{L}} \\ Or , k = \frac{( {D}_{H}^{2} - {D}_{L}^{2} - {D}_{R}^{2} ) \cdot n}{2 \cdot {D}_{L}^{2}} \\ when {D}_{L} \geq {D}_{R} \text{:} . \qquad Equation 1$$

Notice that all the variables on the right hand side of above equation are known. The point Pₖ is fetched from the cyclic edge data list 92 that is k counts from P0 in a counterclockwise direction in the cyclic edge data list 92.

A similar approach is used for the situation illustrated in FIG. 7C. However, some of the variables are interchanged in the equation above and point Pₖ is now determined in a clockwise direction in the cyclic edge data list 92. For example,

$$k = - \frac{( {D}_{H}^{2} - {D}_{L}^{2} - {D}_{R}^{2} ) \cdot n}{2 \cdot {D}_{R}} \\ when {D}_{L} < {D}_{R} \text{:} \qquad Equation 2$$

Notice also that if P₋ₙ, P₀ and P₊ₙ are collinear then D_{L}²=D_{R}² and D_{H}²=4 ·D_{L}². Hence, k=2·n in Equation 1. Thus, the algorithm will make a big leap whenever it operates in a collinear region, i.e., the algorithm will make big leaps until it comes close to a corner.

The process then returns to step S102-2.

If the result of the determination at step S102-5 is YES, then point P0 is designated as an estimated corner, and the process proceeds to step S102-7 to determine if more estimated corners are to be determined.

At step S102-7, it is determined whether all estimated corners been detected, i.e., located, in cyclic edge data list 92. If the determination at step S102-7 is NO, then the process returns to step S102-1 to process the cyclic edge data list 92 and locate the next corner.

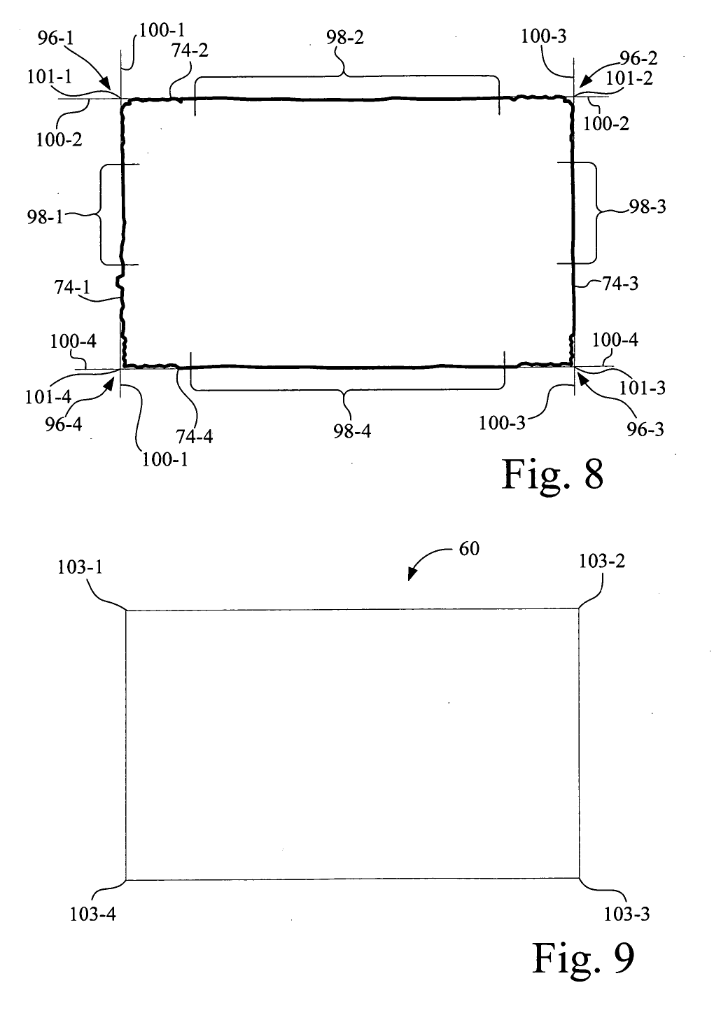

FIG. 4C illustrates the corners 96-1, 96-2, 96-3, 96-4, which were estimated by the process of step S102 of FIG. 5. Since each corner is detected from points from a cyclic edge data list, e.g., cyclic edge data list 92, the corner must always be on the edge 74. However, as shown in the magnified views in FIG. 4C and FIG. 8, due to this and the fact that a corner may be rounded (see corners 96-1, and 96-2, or have local wiggles (see corners 96-2 and 96-3), the estimated corner found may not be a good marker of the object boundaries. As a result, further processing may be desired, as provided in steps S104, S106 and S108 of FIG. 5.

Accordingly, if the determination at step S102-7 is YES, then the process proceeds to step S104.

At step S104, referring to FIG. 8, segment data corresponding to edge segments of the edge data representing edges 74 is determined by ignoring edge data within a predetermined distance from the estimated corners, e.g., 96-1, 96-2, 96-3, and 96-4. In the example of FIG. 8, the segment data corresponds to edge segments 98-1, 98-2, 98-3, and 98-4. Using the edge segments 98-1, 98-2, 98-3 and 98-4 avoid problems associated with a rounded corner or local wiggles in the edge data representing edges 74, as illustrated by edges near to, and including, corners 96-1, 96-2, 96-3, and 96-4.

At step S106, the segment data corresponding to the edge segments 98-1, 98-2, 98-3 and 98-4 is extended linearly to define a plurality of lines 100-1, 100-2, 100-3 and 100-4 having points of intersection 101-1, 101-2, 101-3, and 101-4. The segment data is extended, for example, by processing the segment data representing the points of each edge segment by using a least squares fit algorithm to obtain a straight line corresponding to each edge segment, and then projecting each straight line a distance sufficient to establish the points of intersection.

At step S108, referring also to FIG. 9, the ideal corners 103-1, 103-2, 103-3, and 103-4 of substrate object 60 are defined at the points of intersection 101-1, 101-2, 101-3, and 101-4 of the plurality of lines 100-1, 100-2, 100-3 and 100-4 shown in FIG. 8.

Those skilled in the art will recognize that the process described above may be repeated to determine the corners of each object under consideration.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

```
APPENDIX
Int findCorner(Int list[maxLength][2], Int seed, Int length) {
  Int X0, X1, X2, Y0, Y1, Y2, Iterations;
  Int K, N, R1, P₀, P₋ₙ, P₊ₙ, D_{H}², D_{L}², D_{R}²;
  Int thresholdA = 100, thresholdB = 100;
  Iterations = 0;
  P₀ = seed;
  N = 100;
    Do {
    P₊ₙ = P₀+n;
    P₋ₙ = P₀ − n;
    If (P₊ₙ > length) P₊ₙ −= length;
    If (P₋ₙ < 0) P₋ₙ += length;
    X0 = list[P₀][0]; Y0 = list[P₀][1];
    X1 = list[P₋ₙ][0]; Y1 = list[P₋ₙ][1];
    X2 = list[P₊ₙ][0]; Y2 = list[P₊ₙ][1];
    D_{H}² = (X2−X1)*(X2−X1) + (Y2−Y1)*(Y2−Y1);
    D_{L}² = (X1−X0)*(X1−X0) + (Y1−Y0)*(Y1−Y0);
    D_{R}² = (X2−X0)*(X2−X0) + (Y2−Y0)*(Y2−Y0);
    R1 = D_{H}² − D_{L}² − D_{R}²;
    If (R1 < thresholdA) break; //Corner found
    If (D_{R}² − D_{L}²> thresholdB) {
      K = −R1*N/(2* D_{R}²); //Equation 2
    }
    Else K = R1*N/(2* D_{L}²); //Equation 1
    P₀ += K; //New position (Pₖ)
    If (P₀ < 0) P₀ += length;
    Iterations++;
  } while (P₀ < length && Iterations < maxIterations && abs(K) > 5);
  If (P₀ > length) P₀−= length;
  If (P₀ < 0) P₀ += length;
  Return P₀;
}
```

What is claimed is:

1. A method for determining corners of an object represented by image data, comprising:
determining edge data associated with said object;
finding estimated corners for said edge data;
determining segment data of said edge data by ignoring data within a predetermined distance from said estimated corners;
extending said segment data to define a plurality of lines having points of intersection; and
defining ideal corners at said points of intersection of said plurality of lines.

2. The method of claim 1, wherein said segment data is extended by processing said segment data using a least squares fit algorithm to obtain a straight line for each segment represented by said segment data, and then projecting each said straight line a distance sufficient to establish said points of intersection.

3. The method of claim 1, wherein said object is a substantially rectangular substrate.

4. The method of claim 1, wherein said substantially rectangular substrate is one of a document and a photograph.

5. The method of claim 1, wherein said object represented by said image data is one of a plurality of objects represented by said image data.

6. The method of claim 1, wherein said edge data of said object includes at least two substantially orthogonal edges.

7. The method of claim 1, wherein said image data is generated during a scanning operation, said image data including outer boundary data, background data and foreground data, said foreground data corresponding to said object.

8. The method of claim 7, wherein said background is represented in said image data at a background level, said method further comprising clipping said outer boundary data to said background level.

9. The method of claim I, wherein the act of determining edge data includes:
processing said image data to generate a cyclic list of connected points along edges of said object;
filtering out any branched edges in said edge data.

10. A method for determining corners of an object represented by image data, comprising:
(a) processing said image data to generate a cyclic edge data list of connected points along edges of said object;
(b) identifying an origin point P0 from said connected points;
(c) fetching a first point P₋ₙ a distance DL from point P0 in a clockwise direction in said cyclic edge data list, wherein n is a count value;
(d) fetching a second point P₊ₙ, a distance DR from P0 in a counterclockwise direction in said cyclic edge data list;
(e) determining a distance DH between said first point P₋ₙ and said second point P₊ₙ; and
(f) if DH²=DL²+DR²+Tr, wherein Tr is a tolerance range, then point P0 is designated as an estimated corner.

11. The method of claim 10, further comprising filtering out any branched edges in said cyclic edge data list prior to identifying said origin point P0.

12. The method of claim 10, wherein if DH²>DL²+DR²+Tr, then point P0 is not at an estimated corner, and the method further comprising:
(g) selecting a new origin point P0=P0+k, wherein k is an offset count value; and
(h) repeating acts (c) though (f).

13. The method of claim 12, wherein acts (c) through (h) are repeated until all estimated corners are identified.

14. The method of claim 13, further comprising:
determining segment edge data from said cyclic edge data list by ignoring data within a predetermined distance from said estimated corners;
extending said segment edge data to define a plurality of lines having points of intersection; and
defining ideal corners of said object at said points of intersection of said plurality of lines.

15. The method of claim 14, wherein said segment data is extended by processing said segment data using a least squares fit algorithm to obtain a straight line for each segment represented by said segment data, and then projecting each said straight line a distance sufficient to establish said points of intersection.

16. The method of claim 12, wherein k is selected by the equation:
$$k = \frac{( {D}_{H}^{2} - {D}_{L}^{2} - {D}_{R}^{2} ) \cdot n}{2 \cdot {D}_{L}^{2}}$$

17. The method of claim 12, wherein k is selected by the equation:
$$k = - \frac{( {D}_{H}^{2} - {D}_{L}^{2} - {D}_{R}^{2} ) \cdot n}{2 \cdot {D}_{L}^{2}}$$

18. The method of claim 10, wherein said tolerance range Tr is zero.

19. The method of claim 10, wherein said tolerance range Tr is 0.0 to 0.1 millimeters.

20. A method for determining corners of an object represented by image data, comprising:
(a) processing said image data to generate a cyclic edge data list of connected points along edges of said object;
(b) filtering out any branched edges in said cyclic edge data list;
(c) identifying an origin point P0 from said connected points;
(d) fetching a first point P₋ₙ a distance DL from point P0 in a clockwise direction in said cyclic edge data list, wherein n is a count value;
(e) fetching a second point P₊ₙ a distance DR from P0 in a counterclockwise direction in said cyclic edge data list;
(f) determining a distance DH between said first point P₋ₙ and said second point P₊ₙ; and
(g) if DH²>DL²+DR²+Tr, then point P0 is not at an estimated corner, then the method further:
(h) selecting a new origin point P0=P0+k, wherein k is an offset count value; and
(i) repeating acts (d) though (g).

21. The method of claim 20, wherein acts (c) through (i) are repeated until all estimated corners are identified.

22. The method of claim 21, further comprising:
determining segment edge data from said cyclic edge data list by ignoring data within a predetermined distance from said estimated corners;
extending said segment edge data to define a plurality of lines having points of intersection; and
defining ideal corners of said object at said points of intersection of said plurality of lines.

23. The method of claim 22, wherein said segment data is extended by processing said segment data using a least squares fit algorithm to obtain a straight line for each segment represented by said segment data, and then projecting each said straight line a distance sufficient to establish said points of intersection.

24. The method of claim 20, wherein k is selected by the equation:
$$k = \frac{( {D}_{H}^{2} - {D}_{L}^{2} - {D}_{R}^{2} ) \cdot n}{2 \cdot {D}_{R}^{2}}$$

25. The method of claim 20, wherein k is selected by the equation:
$$k = - \frac{( {D}_{H}^{2} - {D}_{L}^{2} - {D}_{R}^{2} ) \cdot n}{2 \cdot {D}_{L}^{2}}$$

26. The method of claim 20, wherein said tolerance range Tr is zero.

27. The method of claim 20, wherein said tolerance range Tr is 0.0 to 0.1 millimeters.
